(19) United States
(12) Patent Application Publication
(10) Pub. No.: US 2013/0126546 A1
(43) Pub. Date: May 23, 2013

(54) MULTIFUNCTION SYSTEM

(71) Applicant: Gerard Kuma, Nice (FR)

(72) Inventor: Gerard Kuma, Nice (FR)

(73) Assignees: Cecile Ceriani, Nice (FR); Gerard Kuma, Nice (FR)

(21) Appl. No.: 13/642,788

(22) PCT Filed: Jan. 21, 2011
(86) PCT No.: PCT/FR2011/000042

§ 371 Date: Jan. 8, 2013

(30) Foreign Application Priority Data
Apr. 22, 2010 (FR) 1001725
Apr. 22, 2010 (FR) 1001726

(51) Int. Cl. G07F 9/02

(52) U.S. Cl. CPC G07F 9/023
USPC 221/2

(57) ABSTRACT

The invention relates to a multifunction system comprising a first automatic object distribution module (1), a second object recuperation module (21), and a third communication module (15), said third communication module being associated with means for communicating with an administrator of the system within Internet-type networks.

This invention relates to the field of the automatic distribution of articles and, more particularly, the field of the conservation, storage and recycling of commercial articles.

Observing the uses within different establishments, in particular establishments for fast food, school establishments, parks, museums, movie theatres, or sports clubs, has shown that the article distribution networks are not fully satisfactory, in particular for geographical, management and network connection reasons. A service that is not guaranteed during the entire range of opening time of the establishments, the availability of the personnel or benevolent persons according to the organizational diagram, the cash register problems or making change, combined with the difficulties inherent to the management of stocks makes making articles available in an optimal manner difficult.

Furthermore, another major problem which occurs in these establishments, relates to the storage and recycling conditions of articles. It seems indeed that the storage of articles in inappropriate premises, which can be subjected to substantial temperature differences, can alter the properties of said articles. So, it is essential to ensure that the properties of the articles remain constant and unchanged before they are used.

It does effectively happen that certain articles, as for example tennis balls, photographic films or even certain drinks are, before they are used, unusable or inedible. The modifications of the properties of the articles can be due to environmental factors such as in particular substantial differences in temperature, humidity, conditions concerning sunlight or light and/or pressure.

Likewise, certain articles, according to the materials that they are comprised of, can be subjected to changes in form under certain conditions of pressure and/or temperature, making the product improper for sale.

The collection or recovery of articles with a view to recycle them is also a problem in the establishments. To date, there are still no solutions that have a low carbon footprint.

It is known from document FR 2 620 548, the use in a tennis club, of an automatic distributor in monitored premises to deliver balls contained in their original tube by the intermediary of a change machine.

Automatic tennis ball tube distributors with high robustness are also known in document FR 2 604 277. These automatic distributors are, according to this document, well adapted to be arranged outdoors, as well as in an enclosed environment or on the tennis courts.

Finally, document FR 2 616 566 further discloses a device intended for the distribution of tubes containing tennis balls.

However, none of the distributors according to the documents hereinabove incorporate the possibility of recovering articles such as tubes of tennis balls or the used or unusable tennis balls.

Also, an objective of this invention is to provide a system making it possible to deliver articles, as well as providing the possibility of recovering used, empty and/or unusable articles within said system with an aim to their future recycling, and to distribute information in audio, photo and/or video format via an integrated communication interface.

The invention therefore has for first objet a multifunction system comprising:

a first module for the automatic distribution of articles;

a second module for recovering articles; and

a third communication module, said third communication module being associated with means for communicating with an administrator of said system within networks of the Internet type.

Advantageously, the system according to the invention comprises an active matrix screen (TFT for Thin Film Transistor) or a Liquid Crystal Display (LCD).

Applicant has been able to demonstrate that by associating within the same system, a function for the automatic distribution of articles, a function for the recovering of articles and waste and a function for communicating, it becomes possible to respond to an expectation of the establishments, in particular establishments for fast food, school establishments, parks, museums, movie theatres or sports clubs, in terms of local services. Likewise, the function of recovering articles allows establishments to take part in a sustainable development approach making it possible to reduce the costs of waste management as well as their greenhouse gas inventory. Indeed, once the waste has been collected in a single point, the taking up of said waste and the collection of the articles can be accomplished synchronously in a single operation. Finally, the last communication module can allow establishments to distribute programs or advertisements.

More preferably, the first module for distribution the second module for recovery and the third communication module are held together.

Advantageously, the collection or recovery of articles can be combined with the supplying of the distribution portion of the system, the two steps being carried out in a single operation by the service provider.

None of the documents from prior art suggests to combine, within the same system, a distribution module, a recovery module and a communication module.

The invention has as a second object the use of a multifunction system according to the invention for the distribution of articles, the recovering and/or the reduction of said used, empty and/or unusable articles, before they are recycled, and for the distribution of information on said multifunction system.

Other purposes, advantages and characteristics of the invention shall be better understood when reading the following description and preferred embodiments, which are not restrictive, of the objet and of the scope of this patent application and which are drafted with regards to the annexed drawings, wherein:

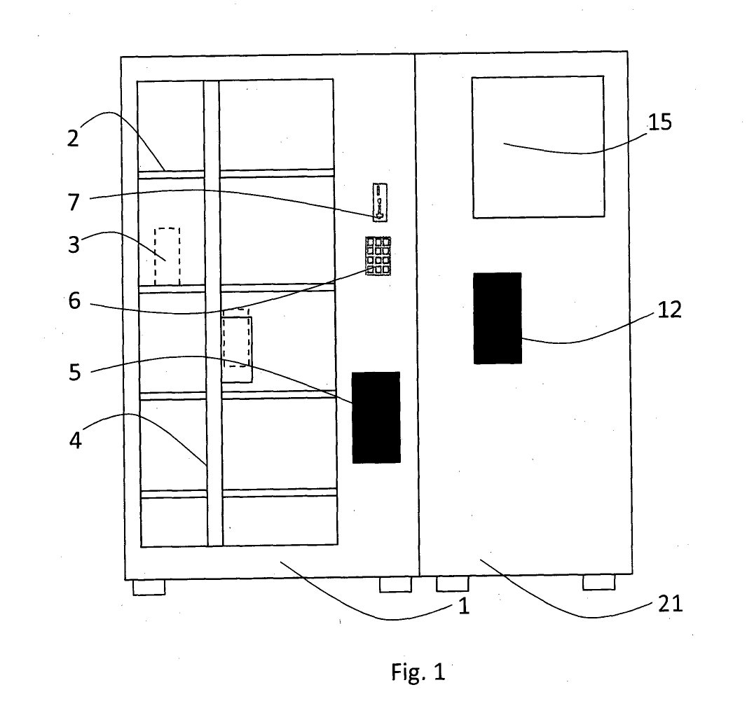

FIG. 1 diagrammatically shows a front view of an embodiment of the multifunction system according to the invention; and

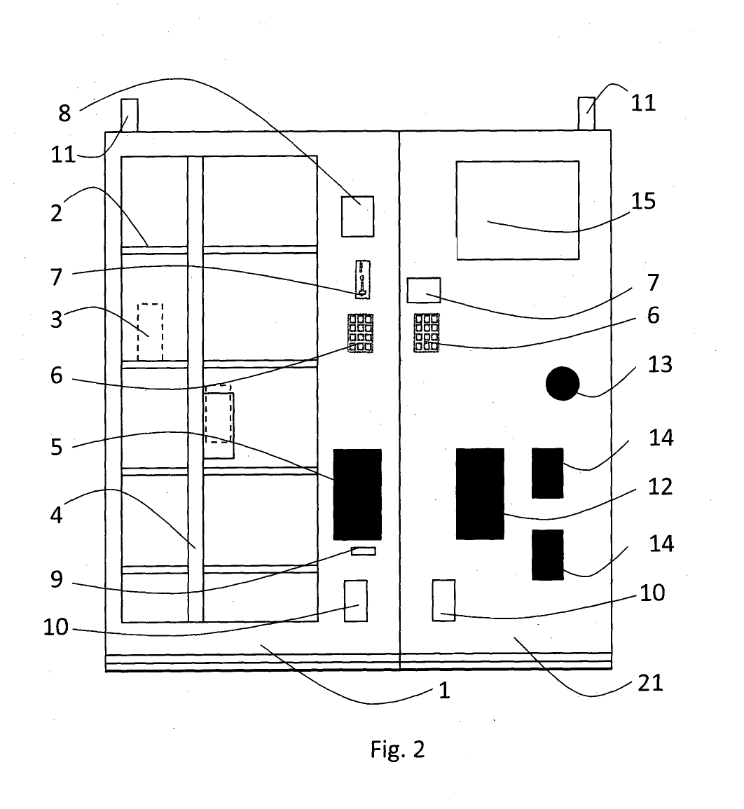

FIG. 2 diagrammatically shows a front view of a second embodiment of the multifunction system according to the invention.

FIGS. 1 and 2 show different possible alternatives of embodiments of automatic multifunction systems according to the invention. As such, according to FIGS. 1 and 2, the systems include a first module for distributing articles 1, allowing for the distribution of articles 3 such as in particular balls for sports or tubes comprising balls for sports, glasses (binoculars, 3D glasses, sunglasses), computer equipment, medical equipment (gloves, antibacterial solutions, single-use sterile smocks, caps, etc.), personal protection equipment, photographic equipment (memory cards, photographic films, USB storage keys, etc.), pedagogical equipment (books, MP3 audio players, audio headsets, etc.), sports accessories (surgrips, anti-vibration systems, tennis wristbands, socks, towels, etc.). Said articles 3 are arranged on stages 2 and can be delivered at a bin for recovering the product and/or change 5 by a motorized elevator 4 in a X and Y plane. More preferably, the elevator is activated after insertion of the corresponding sum in a payment mean 7 and after composition of the code making it possible to deliver the chosen product on a selection keyboard 6. The systems shown in FIGS. 1 and 2 further contain a second module for recovering used, empty and/or unusable articles 21. The recovery of said articles can be carried out by the same entry 12 such as shown in FIG. 1, or by two different entries 12, 13 such as shown in FIG. 2.

Among the articles likely to be delivered by the first module 1 according to the invention, products that can be refrigerated chosen from among beverages and/or food can also be mentioned. By way of non-restricted examples of tennis accessories, racket overgrips, anti-vibration systems or tennis wristbands can be mentioned. By way of non-restricted examples of beverages, mineral waters, fruit juices or sodas can be mentioned, in conventional formats such as 25 cl, 33 cl, 50 cl or 125 cl.

By way of non-restricted examples of food, products enriched with carbohydrates can be mentioned, in particular confectionery such as chocolate bars, products adapted for athletes, etc.

Among the other distribution mechanisms that can be used for the first module 1 according to the invention, spirals, conveyor belts or revolving doors can be mentioned by way of non-restricted example. As shown in FIGS. 1 and 2, in a preferred manner, the distribution mechanism of the first module 1 according to the invention is a motorized elevator in a X and Y plane, more preferably encore, the elevator consists in a robotized arm system in a X and Y plane. This distribution mechanism has the advantage of gently delivering the products thanks to its robotized arm system.

More preferably, the first module 1 according to the invention further comprises a payment mean. By way of non-restricted examples of payment means, change machines, card readers, bank note acceptors or contactless payments can be mentioned in particular. Advantageously, the payment mean is a change machine 7 such as shown in FIGS. 1 and 2.

By way of non-restricted example of a card reader, bank card readers and the electronic wallet can be mentioned such as in particular the Moneo® electronic wallet available in France.

The distribution module 1 according to the invention can contain more preferably between 10 and 100 rows of articles, each row comprising between 4 and 30 articles. More preferably still, the module 1 comprises between 20 and 64 rows of articles, each row comprising between 6 and 10 articles.

Advantageously, the height of the first module 1 according to the invention is between 1200 and 2400 mm, more preferably between 1400 and 2000 mm, more preferably still, the height is 1830 mm.

The width of the first module 1 according to the invention is preferentially between 400 and 1600 mm, more preferably still between 750 and 990 mm.

The depth of the first module 1 according to the invention is preferentially between 400 and 1500 mm, more preferably still, the depth is approximately 870 to 880 mm.

The weight of the first module 1 according to the invention is preferentially between 200 and 1000 kg, more preferably still, the weight is approximately 400 kg.

According to the invention, the system further includes a waste recovery module 21. In order to be in line with an ecological approach, the system according to the invention is also capable of recovering the used, empty and/or unusable articles that it distributes, as well as miscellaneous organic or inorganic waste. Advantageously, the second module 21 according to the invention recovers the other organic or inorganic waste, via the same entries 12 and/or 13, or via one or several additional entries 14 as shown in FIG. 2.

Organic waste here means fermentable waste. This is residue of plant or animal origin which can be broken down by micro-organisms for which they represent a source of food. They include in particular plants, putrescible waste, dirty papers and cartons.

Inorganic waste here means solid waste with a glass, paper, metal base and plastic materials. By way of non-restricted examples of inorganic waste, products that can be recycled can be mentioned such as beverage cans, plastic or glass bottles or carton bricks.

Advantageously, the height of the second module 21 according to the invention is between 1200 and 2400 mm, more preferably between 1400 and 2000 mm, more preferably still, the height is 1830 mm.

The width of the second module 21 according to the invention is preferentially between 150 and 1200 mm, more preferably still between 200 and 400 mm.

The depth of the second module 21 according to the invention is preferentially between 400 and 1500 mm, more preferably still, the depth is approximately 870 to 880 mm.

The weight of the second module 21 according to the invention is preferentially between 20 and 1000 kg, more preferably still, the weight is approximately 70 kg.

Advantageously, said second module has a capacity making it possible to contain the equivalent in volume of the content in articles of the first module according to the invention.

According to a first alternative as shown in FIG. 1, the waste recovery module 21 comprises a single entry 12. This single entry has for advantage to reduce the encumbrance, the costs of manufacture, maintenance and energy consumption.

According to a second alternative shown in FIG. 2, the waste recovery module 21 comprises several entries 12, 13 and/or 14. This plurality of entries allows for the realization of a selective sorting of waste and this, before the step of collection with a view to recycling.

When the system is arranged outdoors, it is preferentially energetically autonomous. The energy autonomy also falls in line with a sustainable development approach. In addition to the practical aspect (the terminal placed outdoors cannot be systematically connected to the network), the autonomy is a non-negligible argument. As such, more preferably, the energy autonomy of the system according to the invention is obtained by the use of a photovoltaic solar system.

According to another embodiment of the invention, the second module 21 further comprises a payment mean 7 of the card reader or contactless payment type, and a selection keyboard 6, as detailed hereinabove.

The system according to the invention further comprises a third communication module also called Media Player. Said communication module is more preferably integrated into the system and comprises a built-in dynamic screen 15 with directional sound. Said communication module can allow in particular the distribution of programs or advertisements. Further advantageously, the communication module receives information relayed by satellite and/or by power line communication (PLC), i.e. that require a simple connection to the network power. This makes it possible to have ultra-light maintenance, self-repair functions, a remotely-controlled distribution of information and telematic management.

By way of example, this dematerialized communication makes it possible to save costs in publications in particular, allows for an acceleration in exchanges within the sector and also is in line with a sustainable development approach, in that it reduces waste linked to the publication of information. The communication module is advantageously a media which makes it possible in particular to distribute a quality audiovisual loop that is updated on a regular basis, free spaces reserved for the communication of the establishment.

By way of a non-restricted example of Media Player that can be used according to the invention, the models marketed by the Spinetix™ company can be mentioned, in particular the HMP100™ model.

Advantageously, the system according to the invention can further contain:

one or several screens and/or one or several cut-outs for payment system 8 such as shown in FIG. 2;

one or several coin returns 9 such as shown in FIG. 2;

one or several closing valves 10 such as shown in FIG. 2;

one or several wall fastenings 11 such as shown in FIG. 2 making it possible to maintain fastened the first and second modules 1 and 21;

one or several windows, preferentially thermo-isolated panoramic windows.

Advantageously, the first module according to the invention comprises an electronic or thermostat-controlled refrigeration system. More preferably, the refrigeration system is with electronic refrigeration and makes it possible to have a temperature between +6° C. and +25° C., more preferably between +8° C. and +14° C.

Of course, the invention is not limited to the embodiments described and shown in the attached figures and those skilled in the art can, using routine operations, realize other embodiments that are not described explicitly, without leaving the framework and the scope of this invention.

1. A multifunction system comprising:
a first module for the automatic distribution of articles;
a second module for recovering articles; and
a third communication module, said third communication module being associated with means for communicating with an administrator of said system within networks of the Internet type.

2. A system according to claim 1, comprising an active matrix screen (TFT for Thin Film Transistor) or a Liquid Crystal Display (LCD).

3. A system according to claim 1, wherein the articles are chosen from among balls for sports, glasses, computer equipment, medical equipment, personal protection equipment, photographic equipment, pedagogical equipment, sports accessories, beverages and/or food.

4. A system according to claim 3, wherein the articles are chosen from among medical equipment and the medical equipment is chosen from among gloves, antibacterial solutions, single-use sterile smocks and caps.

5. A system according to claim 3, wherein the articles are chosen from among photographic equipment and the photographic equipment is chosen from among memory cards, photographic films or USB storage keys.

6. A system according to claim 3, wherein the articles are chosen from among pedagogical material and the pedagogical material is chosen from among books, audio players of MP3 audio players and audio headsets.

7. A system according to claim 3, wherein the articles are chosen from sports accessories and the sports accessories are chosen from among surgrips, anti-vibration systems, tennis wristbands, socks, and towels.

8. A system according to claim 1, which allows for the recovery and/or the reduction of other organic or inorganic waste.

9. A method of using a multifunction system according to claim 1, comprising performing the distribution of articles, the recovering and/or the reduction of said used, empty and/or unusable articles, before they are recycled, and the distribution of information on said multifunction system.

10. A method according to claim 9, wherein the information is distributed in audio, photo and/or video format.

11. A system according to claim 2, wherein the articles are chosen from among balls for sports, glasses, computer equipment, medical equipment, personal protection equipment, photographic equipment, pedagogical equipment, sports accessories, beverages and/or food.

12. A system according to claim 11, wherein the articles are chosen from among medical equipment and the medical equipment is chosen from among gloves, antibacterial solutions, single-use sterile smocks and caps.

13. A system according to claim 11, wherein the articles are chosen from among photographic equipment and the photographic equipment is chosen from among memory cards, photographic films or USB storage keys.

14. A system according to claim 11, wherein the articles are chosen from among pedagogical material and the pedagogical material is chosen from among books, audio players of MP3 audio players and audio headsets.

15. A system according to claim 11, wherein the articles are chosen from sports accessories and the sports accessories are chosen from among surgrips, anti-vibration systems, tennis wristbands, socks, and towels.

16. A system according to claim 2, which allows for the recovery and/or the reduction of other organic or inorganic waste.

17. A system according to claim 3, which allows for the recovery and/or the reduction of other organic or inorganic waste.

18. A system according to claim 4, which allows for the recovery and/or the reduction of other organic or inorganic waste.

19. A system according to claim 5, which allows for the recovery and/or the reduction of other organic or inorganic waste.

20. A system according to claim 6, which allows for the recovery and/or the reduction of other organic or inorganic waste.
